(19) United States
(12) Patent Application Publication
(10) Pub. No.: US 2008/0098952 A1
(43) Pub. Date: May 1, 2008

(54) Promotional apparatus for visually confirming wind conditions

(76) Inventors: David R. Healy, Orono, MN (US); Brian R. Trachsel, Oronoco, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/588,818

(22) Filed: Oct. 27, 2006

(51) Int. Cl. G08B 5/40

(52) U.S. Cl. 116/214

(57) ABSTRACT

A promotional item for simultaneously identifying existing wind conditions while displaying a visual promotional element. The promotional items includes a container and cap that holds a quantity of a powdered material. The container can include a display face prominently featuring the visual element. The container can be formed to resemble an activity specific items such as a golf ball with dimples. By quickly squeezing and releasing the container, a quantity of the powdered material is dispelled through an opening portion in the cap into the surrounding air where it visually interacts with any wind to so as to provide an indication of wind direction and intensity. The visual element can be printed directly onto the container or may be pre-printed on a sticker or substrate, providing attachment onto the container and can include logos, names, trademarks, pictures, phone numbers, web addresses and the like as well as combinations thereof.

### FIELD OF THE INVENTION

The present invention relates generally to promotional items for displaying visual information. More particularly, the invention relates to a container for displaying a visual message on an outer portion and for containing a powdered material within that can be sprayed to visually confirm and identify wind direction.

### BACKGROUND OF THE INVENTION

A wide variety of promotional items are frequently used by companies and individuals to advertise their products and services. Generally, these items contain some form of visual identifier or marking that identify the company or individual's name, the name of a product or service or the logo of the company/individual. In many situations, these items are given to customers or potential customers free of charge. In this manner, not only does the company get the benefit of advertising their name or logo but also they engender good will with the individuals who receive the promotional item.

Due to the large number of people, and more particularly, business men and women who enjoy playing golf, a wide variety of promotional items have been developed that are especially targeted to golfers. Frequently, an individual or company marks items such as, for example, golf balls, golf tees, ball markers and divot repair tools with their name, logo or product information. Often these items are given freely to customers and potential customers. These items generally create goodwill with the receiver of the items as not only are they generally free, but they also constitute items necessary to successfully play and enjoy a round of golf.

While there presently exists a number of promotional items that serve the dual purpose of promotion and utility on the golf course, there remains a need for additional tools that allow companies/individuals to further promote their message on the golf course.

### SUMMARY OF THE INVENTION

A promotional item of the present invention accomplishes the simultaneous goals of promotion and utility on the golf course through the use of a novel wind condition system for visually identifying existing wind conditions while displaying a visual element. The novel wind condition system generally comprises a container and cap that holds a quantity of a powdered material. The container can include a display face prominently featuring the visual element and in some embodiments, the container can be formed in an activity specific shape such as, for example, a golf ball with dimples. By quickly squeezing and releasing the container, a quantity of the powdered material is dispelled through an opening portion in the cap into the surrounding air where it visually interacts with any wind to so as to provide an indication of wind direction and intensity. The visual element can be printed directly onto the container or may be pre-printed on a sticker or substrate, which provides attachment onto the container. Representative visual elements can include a logo, a name, a trademark, a picture, a phone number, a web address and the like as well as combinations thereof.

In one aspect of the present invention, a promotional item comprises a container and cap that holds a quantity of a powder material. The container includes a visual element that can be printed directly onto the container or can be printed on a sticker or substrate for subsequent attachment to a display surface on the container. In a preferred embodiment, the container can be formed to resemble a golf ball including a plurality of dimples. The powder material can be ejected through an opening portion in the cap such that the powder interacts with the surrounding air to provide a visual indication of wind conditions such as direction and intensity. In some embodiments, the container can include an attachment member allowing a user to carry the promotional item by attaching it an article of clothing or activity item such as golf cart, golf bag and the like.

In another aspect, the present invention can comprise a method of visually identifying wind direction and wind strength that involves providing a filled container with a quantity of powdered material, opening the container; squeezing the container to disburse an amount of the powdered material; and observing how the powdered material interacts with any wind as it exits the container. In some embodiments, a user can attach the promotional item to a holding article making the promotional item both accessible and easy to carry. In a preferred embodiment, the container can be marked with visual indicia. In some representative embodiments, the container can be formed in an activity specific shape such as, for example, a golf ball.

### BRIEF DESCRIPTION OF THE FIGURES

The invention may be more completely understood in consideration of the following detailed description of various embodiments of the invention in connection with the accompanying drawings, in which:

FIG. 1 is a perspective view an embodiment of a promotional item of the present invention in a closed configuration.

FIG. 2 is a perspective view of the promotional item of FIG. 1 in an open configuration.

FIG. 3 is a front view of an embodiment of a container for use with the promotional item of FIG. 1.

FIG. 4 is a partially hidden, side view of the container of FIG. 3 illustrating a portion of the interior of the container.

FIG. 5 is a top view of the container of FIG. 3.

FIG. 6 is a bottom view of the container of FIG. 3.

FIG. 7 is an end view of an embodiment of a container for use with a promotional item of the present invention.

FIG. 8 is a side view of the container of FIG. 7.

FIG. 9 is side view of the promotional item of FIG. 1 in use for determining wind conditions.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE INVENTION

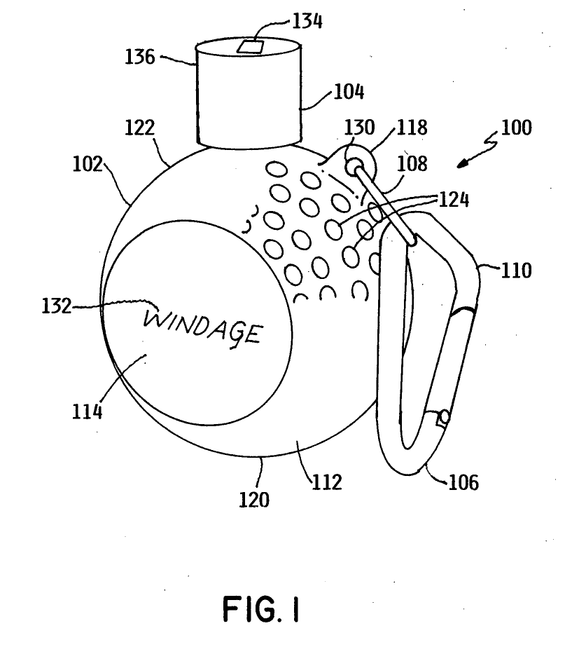

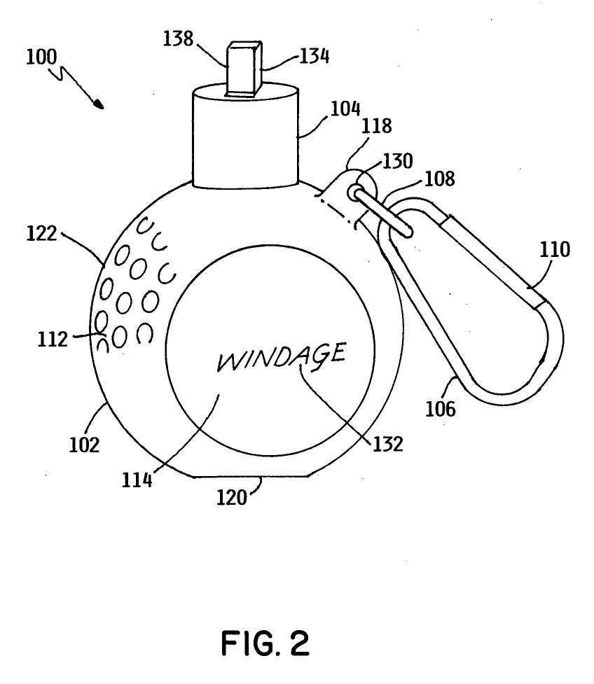

A representative embodiment of a promotional item 100 is illustrated in FIGS. 1 and 2. Generally, promotional item 100 can comprise a container 102, a cap 104 and an attachment member 106. Container 102 and cap 104 can be fabricated of suitable materials of construction including polymeric materials such as polyethylene, polypropylene, polycarbonate and the like. Attachment member 106 can comprise a variety of suitable attachment means including, for example, a key ring 108, a carabiner clip 110 as well as other conventional attachment means and combinations thereof.

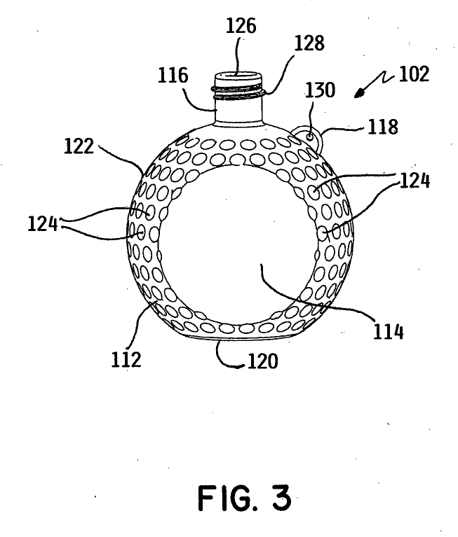

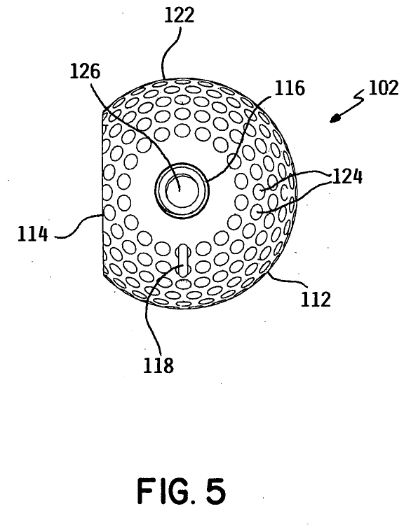

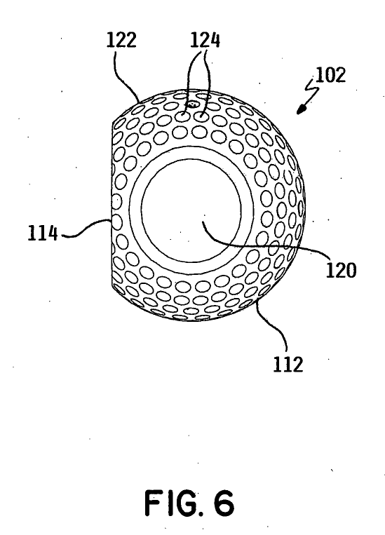

As illustrated in FIGS. 3, 4, 5 and 6, container 102 can comprise a container body 112 having a display surface 114, a neck 116, a projecting ring 118 and a bottom surface 120. Depending upon the market with which the promotional item 100 is being utilized, container body 112 can comprise a variety of market appropriate and specific shapes such as, for example, a golf ball shape 122 having a multitude of dimples 124 spaced around the container body 112 so as to resemble a conventional golf ball. Alternatively, container body 112 may resemble a variety of shapes appropriate for markets and events where wind conditions can play an important role in the overall enjoyment of an activity such as, for example, hunting and sailing. Neck 116 generally defines a container opening 126 and can include a coupling means such as, for example, an engagement thread 128. Projecting ring 118 preferably defines an opening 130 for receiving the attachment member 106. Bottom surface 120 generally defines a flat surface so as to provide the ability for container 102 to be placed in a standing orientation.

Display surface 114 generally comprises a flat surface adapted for the placement of a visual element 132 such as, for example, a logo, a name, a trademark, a picture, a phone number, a web address and the like as well as combinations thereof. Visual element 132 can be printed directly onto the display surface 114 or alternatively, visual element 132 can pre-printed on a sticker or substrate which is subsequently attached to the display surface 114.

Referring again to FIGS. 1 and 2, cap 104 can be fixedly attached to the neck 116. Though not depicted, cap 104 can include an internal thread that interfaces with the engagement thread 128 on the neck 116. Cap 104 can include an opening portion 134 which can pivot from a closed disposition 136 as illustrated in FIG. 1 to an open disposition 138 as illustrated in FIG. 2. Opening portion 134 can take the form of a pivoting lid cover or alternatively, a flip-style spout 140.

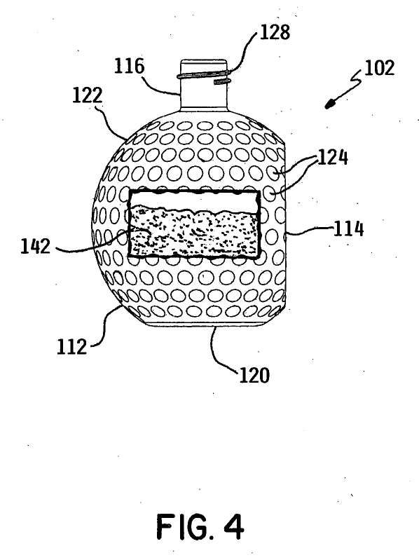

With reference to FIG. 4, container 102 can include an amount of a powder material 142. Powder material 142 can comprise a variety of non-toxic powders such as, for example, finely ground talc, baby powder, talcum powder, powdered chalk and flour. Powder material can comprise a conventional white color or may be dyed to have any of a variety of alternative colors.

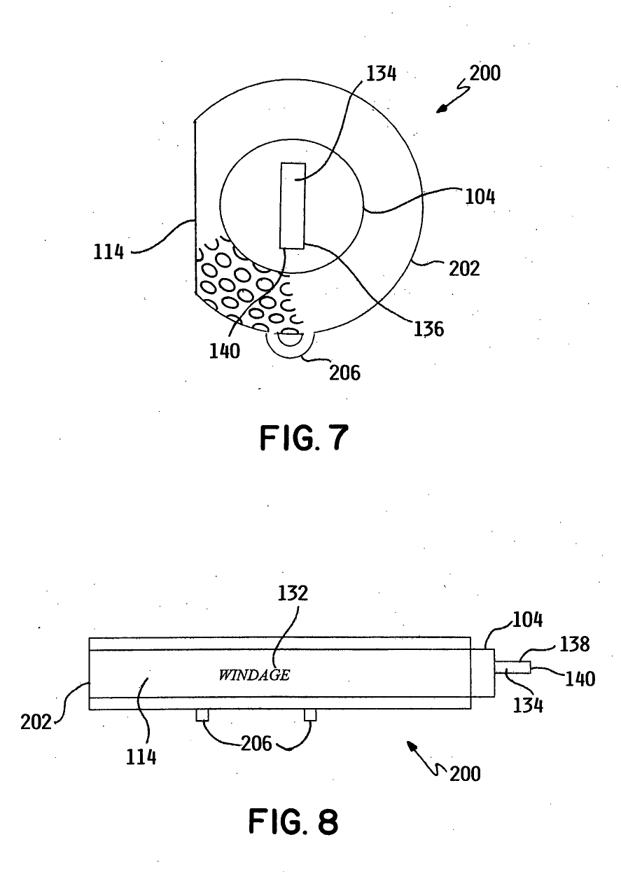

As illustrated in FIGS. 7 and 8, an alternative embodiment of a promotional item 200 can comprise an elongated container 202. When combined with cap 104, elongated container 202 can provide an enlarged storage volume for holding larger amounts of powder material 142. Elongated container 202 can be shaped so as to represent suitable elongated items such as, for example, a golf club. Elongated container 202 can further include one or more retaining elements 206 for retaining items useful with a specified activity such as, for example, a pencil, golf tee or divot repair item.

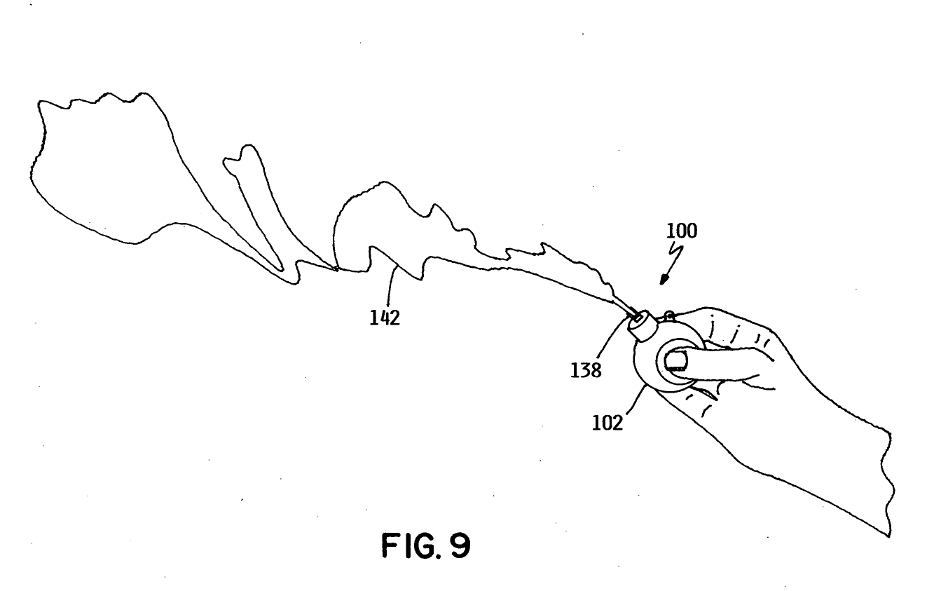

Referring to FIG. 9, promotional items of the present invention including promotional item 100 and promotional item 200 are generally utilized to determine wind conditions including for example, wind direction and intensity. When a user desires to test wind conditions, the opening portion 134 is shifted from closed disposition 136 to open disposition 138. The user then directs the opening portion 134 such that it is not pointed at either the user or other nearby persons and proceeds to quickly squeeze and release the container 102. Squeezing the container 102 causes an amount of powder material 142 to be expelled out of the promotional item 100 and into the surrounding air. At this point, the user simply watches the expelled powder material 142 to see in which direction and how fast it blown by the wind. The user can then utilize this information to assist in making decisions on their next course of action, for instance, club selection and points-of-references for aiming shots on a golf course or course adjustments on a sailboat.

At the same time, the promotional items 100 and 200 are providing wind information to a user, the display surface 114 is causing visual element 132 to be prominently displayed for both the user and any other participants to see. In this manner, the user and other participants associate the information communicated by the visual element 132 with the beneficial information provided by utilizing the promotional items to determine wind characteristics.

Although various embodiments of the invention have been disclosed here for purposes of illustration, it should be understood that a variety of changes, modifications and substitutions may be incorporated without departing from either the spirit or scope of the invention.

1. A promotional item comprising:
a squeezable container having a substantially spherical body with a flat display surface including an exterior visual indicia, the spherical body including a container opening;
a cap attaching to the container to enclose the container opening; and
a powdered material contained within the squeezable container, wherein squeezing the container with the cap in an open position results in a portion of the powdered material being expelled from the container opening whereupon said expelled powdered material provides a visual indication of instantaneous wind conditions.

2. The promotional item of claim 1, wherein the substantially spherical body container includes a plurality of dimples arranged on the substantially spherical body.

3. The promotional item of claim 1, wherein the exterior visual indicia is selected from the group consisting of: a company name, an individual's name, a product name, a logo, a trademark, a web address, a photograph, an illustration, a phone number and combinations thereof.

4. The promotional item of claim 1, wherein the cap comprises a flip-style lid capable of being rotated between the open position and a closed position.

5. The promotional item of claim 1, further comprising:
an attachment member operably connected to a receiving member on the container, the attachment member allowing the container to be retained upon a holding item.

6. The promotional item of claim 5, wherein the holding item is selected from the group consisting of: a golf bag, an item of clothing and a golf cart.

7. The promotional item of claim 1, wherein the powdered material is selected from the group consisting of: finely ground talc, baby powder, talcum powder, chalk and flour.

8. A method for visually identifying wind conditions during a round of golf comprising:
providing a golf-themed promotional item having a squeezable container filled with powdered material, the squeezable container having a substantially spherical body with a flat display panel;
opening a cap on the squeezable container; and
squeezing the squeezable container to expel an amount of the powdered material through the open cap; and
selecting a golf club for playing a next shot based on interaction of the powdered material with any wind.

9. The method of claim 8, further comprising:
attaching the golf-themed promotional item to a holding item that is accessible to a user.

10. The method of claim 8, further comprising:
marking the flat display panel with a visual indicia.

11. The method of claim 8, further comprising:
forming the squeezable container such that the substantially spherical body comprises a plurality of dimples.

12. A golf promotional item comprising:
a squeezable body having a substantially spherical portion and a flat display panel, the substantially spherical body having a plurality of spaced apart dimples and the flat display portion having visible indicia, the squeezable body including an opening and a receiving member;
an attachment member operably connected to the receiving member, the attachment member allowing the squeezable container to be releasably attached to a golf bag;
a positionable cap attached to the opening, the positionable cap rotatably positionable between a closed disposition and an open disposition: and
a powdered material within the squeezable body,
wherein upon squeezing the squeezable body with the positionable cap in the open disposition, the squeezable body and the positionable cap are adapted to expel a portion of the powdered material into a surrounding environment

13. The golf promotional item of claim 12, wherein the attachment member comprises a carabiner clip.

14. The golf promotional item of claim 12, wherein the visual indicia is selected from the group consisting of: a company name, an individual's name, a product name, a logo, a trademark, a web address, a photograph, an illustration, a phone number and combinations thereof.

15. (canceled)

16. (canceled)

17. (canceled)

18. The golf promotional item of claim 12, wherein the positionable cap comprises a flip-style lid.

19. (canceled)

20. (canceled)

21. The golf promotional item of claim 12, wherein the powdered material comprises a non-toxic powdered material.

22. The golf promotional item of claim 21, wherein the non-toxic powdered material is selected from the group consisting of: finely ground talc, baby powder, talcum powder, chalk and flour.
